(19) United States
(12) Patent Application Publication
(10) Pub. No.: US 2013/0134704 A1
(43) Pub. Date: May 30, 2013

(54) ROTATABLE AND BENDABLE CASING CONNECTION

(71) Applicant: Brian K. Klimack, Tofield (CA)

(72) Inventor: Brian K. Klimack, Tofield (CA)

(73) Assignee: KLIMACK HOLDINGS INC., Tofield (CA)

(21) Appl. No.: 13/304,533

(22) Filed: Nov. 25, 2011

(51) Int. Cl. F16L 27/00

(52) U.S. Cl. 285/144.1

(57) ABSTRACT

The present invention provides a casing connection device allowing both bending and rotating motion and that provides three separate sealing areas for leak prevention.

### TECHNICAL FIELD

The present invention relates to a rotatable and bendable casing connection for use in downhole wellbores.

### BACKGROUND OF THE INVENTION

In oil and gas wells where the casing is subject to movement down hole, failures can occur in the casing or in the casing connection. The movement of the casing can be caused by many factors such as shifting formations, formation pressures, overburden pressures, and thermal expansion and contraction from steam injection operations. Stresses induced to the casing from factors such as these, can buckle the casing wall, or cause connections to part or leak. In some cases, the casing is cemented into the well bore, however movements have still been observed and failures still occur. In other cases, where the casing is in an open hole with no cement, movement of the casing liner is often even more severe. Thus, movement from thermal expansion has been seen to affect both cemented and non cemented casings.

Fluids and sands produced from the formations tend to create void spaces in the formation and results in formation pressure decreases. This often causes higher overburden pressures to collapse the formations below, causing further formation movement. When casings reside in these voided formations, they are subject to various loads from the formations and are forced to move with the formations. Any restrictions of movement due to rigidity of the casing can cause buckling or separation of the casing. Casings are most likely to fail at their threaded connections, which tend to be the weakest link in the casing string.

Casing that is subject to thermal expansion and contraction from steam injection often sees larger movements than those created from formation movements. When a casing is cemented in the well, it is held rigidly in the formation. Thermal expansion of the steel casing, even when cemented, is difficult to eliminate. The casing tends to contract or expand within the cement and cause casing damage, damage to the cementing bonds and even damage the formations. In the case of a casing in an open hole, especially in unconsolidated formations such as tar sands, the formation often sloughs off or collapses around the casing. Even though these liners are not cemented, the formation sands collected around the casings can hold the casing in a rigid state like cement. Since these casings are in open holes, they are subject to more formation movement than those that are cemented. Thermal loads experienced by the casings eventually damage them.

Horizontal well drilling is increasingly becoming a popular method of producing oil and gas from formations. Some of these horizontal wells have a shallow vertical depth, and require large degree build angles to hit the target. Casing connections have had to be redesigned in order to handle the severe doglegs from drilling and to place the casing in the wellbore without bending failures.

When there is a casing failure in a well bore, often, the well is lost. A number of scenarios have commonly been observed. The failure of a casing cemented to the surface can often lead to formation pressures or fluids migrating to the surface without having any well control. Casings cemented to the surface that have been crimped can eventually damage completion equipment, and decrease the entry size of the casing to deploy standard size equipment. A failure to produce a casing in open holes can also result in a loss of wells. In a situation where sand control liners are in place and fail due to movement or connection failures, the sand control features of that liner can be lost. Production of sands can make a well uneconomical to operate. A pinched or crimped sand control liner can eliminate passage of other tubing or equipment through the liner, resulting in loss of production or loss of well. Movement of the production liner that is hung from the bottom of an intermediate string can apply side loads to liner hangers and packers, causing them to leak. When cement bonds are damaged in a cemented casing, unwanted communication between formations and between the casing and the formation can occur. When running a rigid casing string through a build section of a horizontal well, often the casing is unable to pass through, or casing connections are damaged due to bending.

All casing connections can withstand bending to some degree, but in most cases, the connection will leak or part when bent. Most connections rely on the threads to deliver a seal, as well as the torque and tensile strength of the connection. Once the thread has a bending load applied to it, the integrity of the connection is drastically reduced or lost completely.

It is therefore desirable to develop a casing connection that can allow bending and rotation of the casing during installation and operation. It is further desirable to provide flexibility to standard, stiff casing so that it can be deployed in more severe doglegs, or bends, without the use of slant drilling rigs.

### SUMMARY OF INVENTION

The present invention thus provides a casing connection device allowing both bending and rotating motion and that provides three separate sealing areas for leak prevention.

### BRIEF DESCRIPTION OF THE DRAWINGS

The present invention will now be described in greater detail, with reference to the following drawings, in which:

FIG. 1 depicts one embodiment of the top face sub portion of the present casing connection;

FIG. 2 depicts one embodiment of the bottom face sub portion of the present casing connection;

FIG. 3 depicts one embodiment of a threaded coupling for use in the present casing connection; and

FIG. 4 depicts one embodiment an assembled casing connection of the present invention.

### DETAILED DESCRIPTION OF THE INVENTION

The present invention provides a casing connection that can allow bending and also bending under rotation. Such a connection must built in a manner that it equals or exceeds the standard connection specifications, so that it can either replace standard connections or work in conjunction with them. The present connection allows bending from any side loads, to allow casing movement without connection failure. The present connection further allows bending in the connection, while the casing is rotated. This allows stiff casing strings to be run through severe well doglegs. When a well is drilled, the location and degree of bending of each dog leg is known from the drilling information. Accordingly, the present connection can be set along a length of casing to align with the downhole dog legs, when the casing is in its final resting position or depth.

The present connection preferably allows for controlled degrees of bending as well as set loads to allow bending to happen. The present connection further preferably acts to seal pressure, withstand applied torque, compression and tensile loads when running casing into the well. It must also seal pressure while loads are applied to the connection during the production phase of the well. These loads would be applied from thermal applications, and formation movements.

In a further embodiment, the present connection allows standard, stiff casing to be deployed into more severe doglegs or bend, in the build section than typically possible. For example, the present connection can allow standard casing to be deployed in bends of up to 15° versus a typical 7° dogleg limit. This allows the forming builds through shallow vertical depths, without the aid of slant drilling rigs.

Typical connections in the art consist of a pin and box connection consisting of a male pin end and a female box end. The box end can be of two styles, the first of which is a coupling connection. The coupling is a short x/o sub with two box ends on it. The coupling is connected to the pin end of the casing and the other end of the casing is also a pin end. Once the coupling is connected to the joint, the joint now becomes a pin x box joint. In the second style, the box end is machined directly to the casing joint body as a flush connection. Flush connections are often weaker due to the lesser cross sectional area of material at the box end, compared to a coupling cross sectional area. The coupling joint has a larger outside diameter than the flush joint, at the box ends of the joint. Coupling connections are usually stronger than flush connections since they are made from more material. In some connections, the coupling connection delivers better sealing than some flush connections.

Typical thread types used on either a coupling or flush connection can vary. There are several different profiles of threads on the market, each delivering a specific quality. Quality varies to deliver better torque, tensile, compressive, bending, and sealing capabilities. All connections rely on the thread profiles to deliver these qualities.

By contrast, the present connection does not depend on the thread type to deliver seal, torque and compressive strengths. Instead, the thread is used only to control maximum tensile loading.

The new connection does not rely on a thread profile to deliver its seal, torque, compressive, or bending qualities. It will rely on threads, only for its tensile load.

The new connection will consist of three major components: a top face sub, a bottom face sub and an adjusting collar.

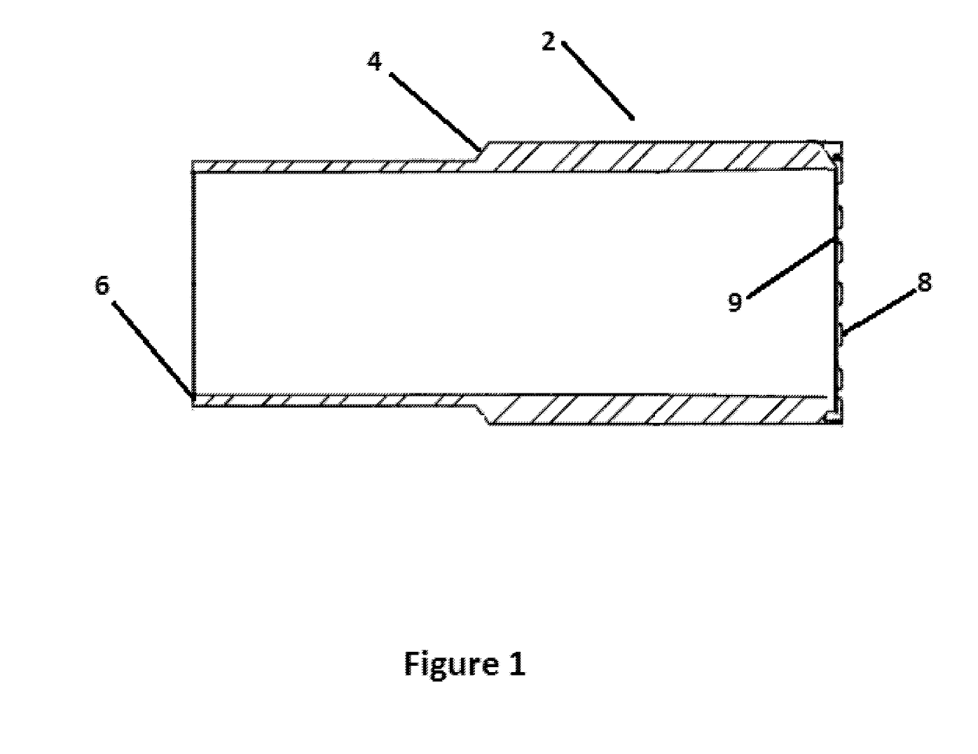

A preferred embodiment of the top face sub 2 is depicted in FIG. 1. The top face sub 2 includes a bored-through inside diameter that is preferably consistent with the nominal inside diameter of the casing that it will be used with. An outside surface of the top face sub 2 includes a first circular radius face 4 to mate with an internal face of the adjusting collar. The top face sub 2 further has a first plain end 6 which can be preferably machined, welded or threaded to match the casing that it will be run with. Most preferably, the first plain end 6 is threaded. A second circular radius face 9 is provided with one or more torque preventing means, preferably in the form of milled with torque cogs 8 along an exterior surface of the second circular radius face 9.

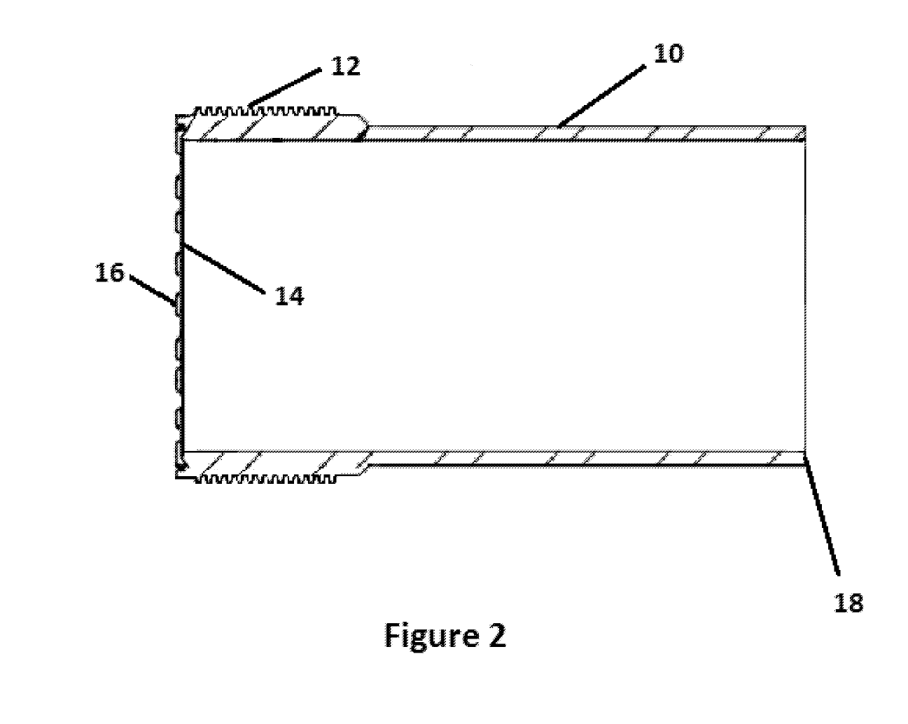

A preferred embodiment of the bottom face sub 10 is depicted in FIG. 2. The bottom face sub 10 includes a bored-through inside diameter to match the nominal inside diameter of the casing that will be used with it. An outside surface of the bottom face sub 10 preferably has a threaded portion 12 to mate to and thread into the adjusting collar. The bottom face sub 10 further includes a machined third circular radius face 14, having one or more torque preventing means, preferably in the form of torque cogs 16 milled to an exterior surface of the third circular radius face 14. The bottom sub face 10 mates with the top face sub 2 by bringing together the second circular radius face 9 and associated torque cogs 8 with the third circular radius face 14 and associated torque cogs 16 such that the sets of torque cogs 8, 16 interlock. The bottom face sub 10 further has a second plain end 18. The second plain end 18 can be preferably machined, welded or threaded to match the casing that it will be run with. Most preferably, the second plain end 18 is threaded.

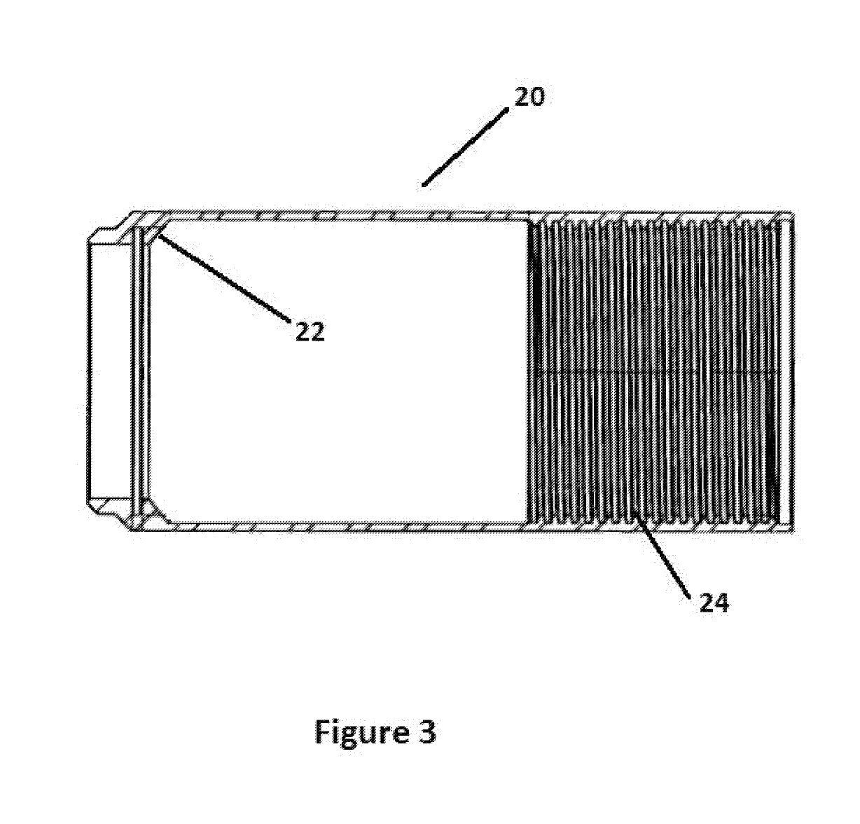

One embodiment of the adjusting collar 20 is depicted in FIG. 3. The adjusting collar 20 has a bore through inside diameter in which an upper portion of the inside diameter is larger than the outside diameter of the first plain end 6 of the top face sub 2. A center portion of the inside diameter of the adjusting collar 20 preferably consists of a machined fourth circular radius face 22, which will mate to the first circular radius face 4 of the top face sub 2. A lower portion of the inside diameter includes a threaded connection 24, which mates to the threaded portion 12 of the bottom face sub 10. In a preferred embodiment the threaded connection 24 of the adjusting collar 20 is a female threaded connection and the threaded portion 12 of the bottom face sub 10 is a male threaded connection. The outside diameter of the adjusting collar 20 preferably resembles the coupling of the casing being used. The adjusting collar 20 can optionally contain one or more set screws (not shown) to secure against any additional movement or makeup to the connection after initial makeup.

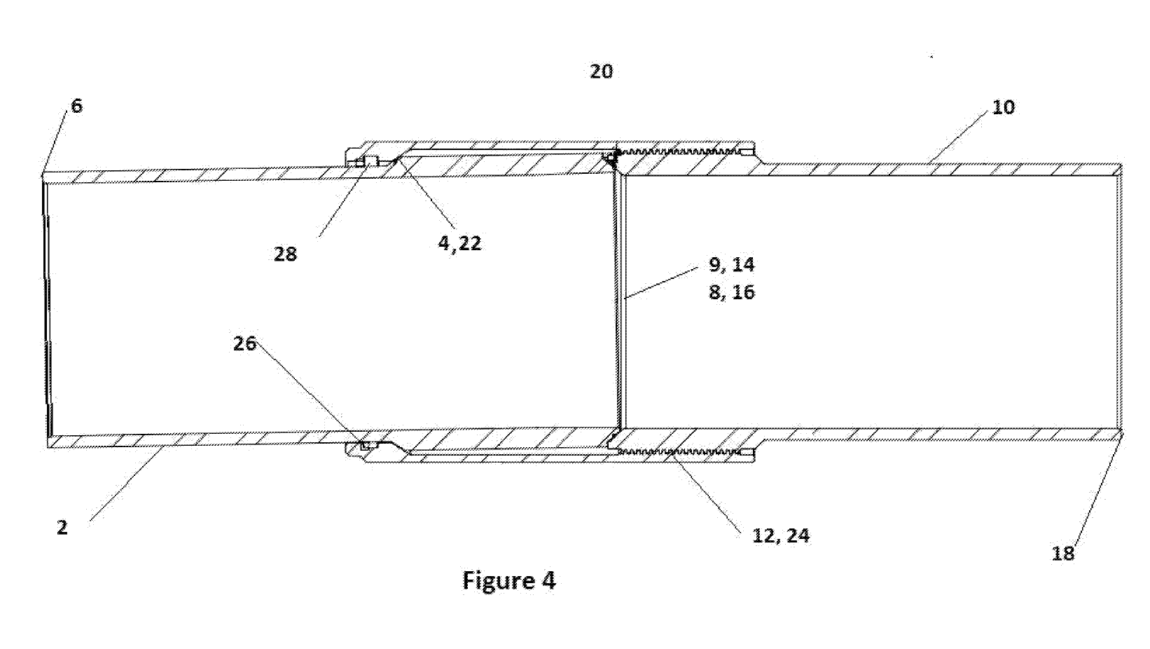

The present connection can be assembled prior to being run in downhole along with the casings. One embodiment of the assembled connection of the present invention is depicted in FIG. 4. To assemble the connection, the adjusting collar 20 is first slid over the first plain end 6 portion of the top face sub 2. The top face sub 2 is then positioned with the bottom face sub 10, such that their mating circular radius faces 9, 14 and torque cogs 8, 16 mate with one another. The adjusting collar 20 is then lowered until the threaded connection 24 of the adjusting collar 20 mates with the thread portion 12 of the bottom face sub 10. The adjusting collar 20 is then rotated to engage the threaded connection 24 with the threaded portion 12 of the bottom face sub 10. The rotation acts to tighten the adjusting collar 20 until the internal fourth circular radius face 22 of the adjusting collar 20 mates to the first circular face 4 of the top face sub 2.

A dust seal 28 and O-ring 26 can be added between the adjusting collar 20 and the top face sub 2 at the interface of the first and fourth circular radius faces 4, 22, to prevent sand from entering the connection and potentially wearing out the connection.

A further optional “O” ring can be inserted within each pair of circular radius faces 4, 22 and 9, 14 to provide additional sealing.

The amount of torque applied to the threaded connections 12, 24 will determine the amount of force required to bend or rotate the top and bottom face subs 2, 10 away from each other along their mating circular radius faces 9, 14 and 4, 22. The amount of force required can be predetermined and set before running the connection downhole, by the extent of tightening applied to the threaded connections 12, 24. The one or more torque preventing means, preferably in the form of mating torque cogs 8, 16 act to prevent over-torque or unscrewing of the connection during rotation and bending downhole. Optionally, any number of known means in the art can be additionally used to prevent against over-torque, or loosening of the connections, including but not limited to set screws or spot welds.

After the present connection is assembled, it is attached to the casing to be used. The present connection provides three separate sealing areas. The first sealing area consists of the seal created by top face sub 2 and bottom face sub 10 circular radius faces 9, 14. The second sealing area consists of the seal created by the top face sub 2 and adjusting collar 20 circular radius faces 4, 22. Finally, the third sealing area consists of the seal created by the adjusting collar 20 and bottom face sub 10 threaded connections 12, 24. In the present connection, a leak path from well annulus to casing interior or vice versa can only develop if two of the three sealing areas fail. That is, a failure of a combination of circular radius faces 9, 14, circular radius faces 4, 22, or circular radius faces 9,14 together with threaded connections 12, 24 would be required to cause a leak. Typical casing connections have only one sealing area, the threaded connection and bending of this threaded connection most commonly contributes to the formation of a leak path in known casing connections.

When the casing and the present connections are run into the downhole well, they will encounter dog legs located in the well as a result of drilling. As the casing is run through these dog legs, the stiffness of the casing can cause the casing to become stuck within the dog leg. In such cases, the present connection allows some bending when induced with bending forces, allowing the casing to conform better to the direction of the bends in the well. If casing has to be rotated through these bends, the present connection can be rotated at the same time it is bending to conform to the wellbore. If the depths or location of the dog legs are predetermined, the present connections can be positioned at predetermined lengths along the casing string that correspond with the depths or locations of the dog legs. This reduces the amount of stress on the casing lengths themselves after the casing has been installed.

In wells where thermal expansion and contraction is evident, the present connection can absorb some of these thermal loads which would otherwise be placed on the threaded portion of typical connections. Most thermal movement observed in the casing is located in the open hole sections of the wells, where casing is allowed to move most freely. In many of these open holes, sand production, fluid production, and formation movements are evident. As voids are created from displaced solids and fluids, formations will shift and create unwanted casing movement.

The movement of a casing within the open hole also affects the forces acting on the casing liner hangers. Most wells will produce closer to the heel of the well than at its toe. Most formation movements are noticed at the heel as well. The increased movement of the casing at the heel area tends to offset the position of the casing liner hanger relative to the cemented intermediate casing by causing a bending load. This typically results in a failure to the seal. By placing the present connection directly after the liner hanger and through the heel area, bending movements are absorbed, placing less stress on the casing liner hanger and the casing connections in the heel area.

In thermal wells where the intermediate casing is cemented to the surface, undesirable loads on the casing have also been observed. In cemented wells, the casing is acted upon by the stresses of thermal expansion and contraction, but is prevented from movement by the cement bond. Since the intermediate casing typically runs through the build section of the well, any casing connections used in this section are already under the strain of bending through the build section and thermal expansion or contraction adds to this stress. The result is often connection seal failures and casing collapse. By placing the present connections in predetermined areas of the cemented intermediate casing, bending is allowed and stresses from the build section and thermal movement can be absorbed thus protecting the casing bodies and casing connections from failure.

The present connections can also be used in a number of different applications such as mining or producing salt caverns or any circumstance where casing are subject to bending for any number of reasons.

The present connection can be optionally manufactured directly onto plain end casings and used as a total casing connection, or it can be assembled to existing threaded casings and specifically placed throughout the casing string as required.

There are no elastomeric elements used for sealing in the present connection. All seals are preferably made of metal, and more preferably made from steel, and can thus withstand extreme temperatures and pressures.

In the foregoing specification, the invention has been described with a specific embodiment thereof; however, it will be evident that various modifications and changes may be made thereto without departing from the broader spirit and scope of the invention.

Having thus described the invention, what is claimed as new and secured by Letters Patent is:

1. A casing connection device allowing both bending and rotating motion and that provides three separate sealing areas for leak prevention.

2. The casing connection of claim 1, further comprising a top face sub, a bottom face sub and an adjusting collar.

3. The casing connection of claim 2, wherein the top face sub comprises a first plain end for mating with a section of casing, a first circular radius face for connecting with the adjusting collar and a second circular radius face comprising one or more torque preventing means.

4. The casing connection of claim 3, wherein the bottom face sub comprises a second plain end for mating with a section of casing, a third circular radius face for connecting with the top face sub and one or more torque preventing means.

5. The casing connection of claim 3, wherein the adjusting collar comprises a bore through inside diameter with an upper portion for connecting with the top face sub, a lower portion for connecting with the bottom face sub.

6. The casing connection of claim 5, wherein the bore through inside diameter of the adjusting collar comprises a center portion having a fourth circular radius face for mating to the first circular radius face of the top face sub.

7. The casing connection of claim 5, wherein the lower portion of the bore through inside diameter of the adjusting collar is machined with a threaded connection to mate to a threaded outside surface of the bottom face sub.

8. The casing connection of claim 3, wherein the top face sub first plain end has a finish that is selected from the group consisting from machined, welded and threaded to match the section of casing.

9. The casing connection of claim 8, wherein the first plain end is threaded.

10. The casing connection of claim 3, wherein the one or more torque preventing means are milled torque cogs along an exterior surface of the first circular radius face.

11. The casing connection of claim 4, wherein the bottom face sub second plain end has a finish that is selected from the group consisting of machined, welded and threaded to match the section of casing.

12. The casing connection of claim 11, wherein the second plain end is threaded.

13. The casing connection of claim 4, wherein the one or more torque preventing means are milled torque cogs along an exterior surface of the third circular radius face.

14. The casing connection of claim 13, wherein the second circular radius face and the third circular radius face mate such that their torque cogs interlock.

15. The casing connection of claim 7, wherein the threaded connection of the adjusting collar is a female threaded connection and the threaded surface of the bottom face sub is a male threaded connection.

16. The casing connection of claim 5, wherein the adjusting collar comprises one or more set screws to secure against rotational movement of the casing connection.

17. The casing connection of claim 14, wherein a first sealing area comprises the mating of the first circular radius face and the fourth circular radius faces, a second sealing area comprises the mating of second circular radius face and the third circular seal faces and a third sealing area comprises the mating of the adjusting collar threaded connection and the bottom face sub threaded connections.

18. The casing connection of claim 14 further comprising a dust seal and an O-ring inserted between the adjusting collar and the top face sub at the interface of the first circular radius face and the fourth circular radius face, to prevent entrance sand into the casing connection.

19. The casing connection of claim 1, wherein the casing connection is employed to connect standard casing for deployment into doglegs having bend angles of up to 15°.
